(19) United States
(12) Patent Application Publication
(10) Pub. No.: US 2023/0079912 A1
(43) Pub. Date: Mar. 16, 2023

(54) AQUEOUS SURFACE TREATING COMPOSITION

(71) Applicant: Momentive Performance Materials Inc., Waterford, NY (US)

(72) Inventors: Anne Dussaud, Tarrytown, NY (US); Ning Lu, Tarrytown, NY (US)

(21) Appl. No.: 17/902,184

(22) Filed: Sep. 2, 2022

Related U.S. Application Data
(60) Provisional application No. 63/241,573, filed on Sep. 8, 2021.

(51) Int. Cl. C09D 5/02; C09D 7/65

(52) U.S. Cl. CPC C09D 5/024; C09D 7/65

(57) ABSTRACT

A surface treating composition is shown and described herein. The surface treating composition is an aqueous composition comprising a polymer resin and an aminosilicone material. The polymer resin and the aminosilicone material may be provided as emulsions. The present compositions employing the aminosilicone may exhibit enhanced slip, hydrophobicity, and/or oleophobicity.

### CROSS-REFERENCE TO RELATED APPLICATIONS

The present application claims priority to and the benefit of U.S. Provisional Application No. 63/241,573, titled “AQUEOUS SURFACE TREATING COMPOSITION,” filed on Sep. 8, 2021, the disclosure of which is incorporated herein by reference in its entirety.

### FIELD OF INVENTION

The present invention relates to an aqueous surface treating composition. In particular, the present invention relates to an aqueous surface treating composition comprising an aminosilicone, surface treatments and coatings formed therefore, and methods of treating a surface using the same.

### BACKGROUND

Waterborne coatings are of interest for their favorable environmental profile compared to solvent-based coatings that may employ volatile organic solvents. Solvent-based coatings, however, tend to exhibit better performance and durability compared to waterborne coatings. One approach to improve the properties of waterborne coatings is to modify the design of the base resin.

Another approach to improve the properties of waterborne coatings is to employ additives that work in concert or synergistically with the waterborne resins. Silicones have been used in coatings to treat hard surfaces. Coatings for hard surfaces are typically solvent-based systems. The use of silicones in waterborne systems is generally more difficult than solvent-based systems. Typical silicones may require the use of larger of amounts of surfactants for the silicones to be compatible with the waterborne resins. The use of larger amounts of surfactants, however, may reduce water resiliency or lead to surfactant leaching out of the coating. Silicone polyethers have good compatibility with acrylic latex and may increase the slip of the coating, but the silicone polyethers have limited durability and hydrophobicity. Silicone gums (e.g., polydimethylsiloxanes) can increase the slip at very low concentrations. Silicone gums, however, tend to cause craters or other film defects and are difficult to use to increase water repellency when used at higher concentrations. In addition, it is preferable that the use of the silicone additive does not affect significantly the finish of the coating, for example glossy or matt finishes. Accordingly, there is a need for silicone based aqueous surface treating compositions that have improved properties, such as durability and hydrophobicity, without producing defects or significantly affecting properties, such as, for example, gloss, particularly when used at higher concentrations.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an aqueous surface treating composition. The aqueous surface treating composition comprises a polymer resin and an aminosilicone material. The inclusion of the aminosilicone material has been found to enhance one or more properties of the surface treating composition such as, for example, the hydrophobicity, oleophobicity, and/or slip. Additionally, inclusion of the aminosilicone does not appear to contribute to or cause any significant negative properties such as defects or craters. The use of the aminosilicones may also not have any significant effect on gloss, e.g., inclusion of the aminosilicones may not decrease or increase gloss significantly.

In one aspect, provided is an aqueous surface treating composition comprising: (a) a polymer resin; and (b) an aminosilicone material selected from a compound of formula (I):

MDₓD′_{y}M (I)

wherein
M=R¹R²₂SiO_{1/2},
D=R³₂SiO_{2/2}, and
D′=R⁴R⁵SiO_{2/2}, and
where R¹ is an alkyl group having 12 to about 50 carbon atoms; R², R³, and R⁴ are each independently selected from a substituted or un-substituted hydrocarbon group having 1 to about 20 carbon atoms; R⁵ is an aminoalkyl or diaminoalkyl group —R⁶—NR⁷R⁸ where R⁶ is a divalent alkylene with 2-12 carbon atoms, R⁷ is H or an alkyl group with 1 to 6 carbon atoms, and R⁸ is H, an alkyl group with 1 to 6 carbon atoms or —R⁹NH2 where R⁹ is an alkylene group with 2 to 12 carbon atoms; x has a value of 1 to about 2,000; and y has a value of 1 to about 50.

In one embodiment, R², R³, and R⁴ are each independently selected from a substituted or un-substituted hydrocarbon group having 1 to 6 carbon atoms.

In one embodiment, R², R³, and R⁴ are each independently selected from methyl, ethyl, butyl, or hexyl.

In one embodiment, R², R³, and R⁴ are each independently selected from a C4-C20 cycloalkyl group, an alkoxy, and a C6-C20 aryl group.

In one embodiment, R², R³, and R⁴ are each independently selected from an alkyl group or an aryl group.

In one embodiment, R², R³, and R⁴ are each independently selected from methyl or phenyl.

In one embodiment in accordance with any of the previous embodiments, R⁵ in the aminosilicone material of the compound of formula (I) is a 3-aminopropyl group and/or a N-(2-aminoethyl)-3-aminopropyl group.

In one embodiment, R¹ is an alkyl group containing from about 15 to about 20 carbon atoms; R², R³, and R⁴ are methyl; and R⁵ is a N-(2-aminoethyl)-3-aminopropyl group.

In one embodiment, R¹ is an alkyl group containing from about 30 to about 45 carbon atoms; R², R³, and R⁴ are methyl; and R⁵ is a N-(2-aminoethyl)-3-aminopropyl group.

In one embodiment in accordance with any of the previous embodiments, the value of x is from about 10 to about 1,500, and the value of y is from about 2 to about 40.

In one embodiment in accordance with any of the previous embodiments, the aminosilicone has a viscosity at 25° C. of about 1,000 to about 5,000,000 mPa·s.

In one embodiment in accordance with any of the previous embodiments, wherein the aminosilicone has a nitrogen content of 0.01 to about 0.3% by weight.

In one embodiment in accordance with any of the previous embodiments, the aminosilicone material is an aminosilicone emulsion comprising the aminosilicone material and a surfactant. In one embodiment, the surfactant is selected from the group consisting of an anionic surfactant, a cationic surfactant, a nonionic surfactant, an amphoteric surfactant, and a combination thereof.

In one embodiment in accordance with any of the previous embodiments, the polymer resin is selected from an acrylic resin, a waterborne polyurethane resin, a waterborne polyester resin, an epoxy resin, an alkyd resin, a vinyl resin, a carbohydrate-based waterborne latex, a protein-based waterborne latex, or a combination of two or more thereof.

In one embodiment in accordance with any of the previous embodiments, the polymer resin is a polymer resin emulsion.

In one embodiment in accordance with any of the previous embodiments, the aminosilicone material is present in an amount of from about 0.01 to about 10 wt. % based on the total weight of the composition.

In one embodiment in accordance with any of the previous embodiments, the aminosilicone material is present in an amount of from about 0.025 to about 0.5 wt. % based on the total weight of the composition.

In one embodiment in accordance with any of the previous embodiments, the aminosilicone material is present in an amount of from about 1 to about 5 wt. % based on the total weight of the composition.

In another aspect, provided is a substrate comprising a surface, wherein at least a portion of the surface is coated with the aqueous surface treating composition of any the previous aspects or embodiments.

In one embodiment, the substrate is wood-based, plasterboard, cement, wallpaper, previously coated surfaces, stucco, leather, plastic-based surfaces, plastic film, paper, cardboard, or metal.

In still another aspect, provided is a method of treating a substrate comprising applying the aqueous surface treating composition of any of the previous aspects embodiments on at least a portion of a surface of the substrate.

In yet another aspect, provided is a method of preparing the aqueous surface treating composition of any of the previous aspects or embodiments comprising mixing the polymer resin (a) and the aminosilicone material (b).

In one embodiment, the polymer (a) is an emulsion, and the aminosilicone material (b) is an emulsion, and the emulsions are mixed together.

The following description and the drawings disclose various illustrative aspects. Some improvements and novel aspects may be expressly identified, while others may be apparent from the description and drawings.

### BRIEF DESCRIPTION OF THE DRAWINGS

FIG. 1 is a photo of a panel painted with a comparative paint example and subjected to surfactant leaching testing;

FIG. 2 is a photo of a panel painted with a comparative paint example and subjected to surfactant leaching testing; and

FIG. 3 is a photo of a panel painted with a paint example in accordance with the present technology and subjected to surfactant leaching testing.

### DETAILED DESCRIPTION

Reference will now be made to exemplary aspects and embodiments, examples of which are discussed in this description. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is an aqueous surface treating composition. The aqueous surface treating composition comprises a polymer resin and an aminosilicone material. The inclusion of the aminosilicone material has been found to enhance one or more properties of the surface treating composition such as, for example, the hydrophobicity, oleophobicity, and/or slip. Additionally, inclusion of the aminosilicone does not appear to contribute to or cause any significant negative properties such as defects or craters.

The aqueous surface treating composition includes an aminosilicone material. In one embodiment, the aminosilicone includes an amino group bonded to a silicon atom and a long chain alkyl group bonded to a silicon atom. The long chain alkyl group generally contains 12 or more carbon atoms in the chain. The amino group can be selected from an amino alkyl group, a diamino alkyl group, etc.

The aminosilicone, in one embodiment, is an amino silicone of formula (I):

MDₓD′_{y}M (I)

wherein
M=R¹R²₂SiO_{1/2},
D=R³₂SiO_{2/2}, and
D′=R⁴R⁵SiO_{2/2}, and
where R¹ is an alkyl group having 12 to about 50 carbon atoms; R², R³, and R⁴ are each independently selected from a substituted or un-substituted hydrocarbon group having 1 to about 20 carbon atoms; R⁵ is an aminoalkyl or diaminoalkyl group —R⁶—NR⁷R⁸ where R⁶ is a divalent alkylene with 2-12 carbon atoms, R⁷ is H or an alkyl group with 1 to 6 carbon atoms, and R⁸ is H, an alkyl group with 1 to 6 carbon atoms or —R⁹NH2 where R⁹ is an alkylene group with 2 to 12 carbon atoms, x has a value of 1 to about 2,000, and y has a value of 1 to about 50.

In aminosilicone of formula (I), R¹ is an alkyl group having 12 to about 50 carbon atoms, and may be linear or branched. In one embodiment, R¹ is a linear or branched alkyl group having 14 to about 50 carbon atoms, about 16 to about 45 carbon atoms, about 20 to about 40 carbon atoms, or about 25 to about 35 carbon atoms. In one embodiment R¹ is a linear or branched alkyl group of from about 15 to about 20 carbon atoms. In one other embodiment, R¹ is a linear or branched alkyl group of from about 30 to about 45 carbon atoms.

In the aminosilicone (I), R², R³, and R⁴ are each independently selected from an un-substituted or substituted hydrocarbon group having 1 to 20 carbon atoms. In one embodiment, the un-substituted or substituted hydrocarbon is selected from a C1-C20 alkyl, a C2-C20 alkenyl, a C4-C20 cycloalkyl, and a C6-C20 aryl. Examples of the un-substituted hydrocarbon groups include, but are not limited to, linear or branched alkyl groups such as, but not limited to, methyl, ethyl, butyl, or hexyl; cycloalkyl groups such as cyclohexyl; alkoxy groups such as methoxy, ethoxy, propoxy or butoxy; aryl groups such as phenyl, tolyl or naphthyl; aralkyl groups such as benzyl, β-phenylethyl or methylbenzyl; alkenyl groups such as vinyl or allyl, and the like. Examples of the substituted alkyl groups are, for instance, but not limited to, fluoroalkyl groups such as 3,3,3-trifluoropropyl, and the like. In one embodiment, R² is selected from an alkyl group or an aryl group. In one embodiment, R² is methyl or phenyl.

In one embodiment R⁵ in aminosilicone (I) is 3-aminopropyl group and/or N-(2-aminoethyl)-3-aminopropyl group.

In one specific embodiment, R¹ is an alkyl group containing from about 15 to about 20 carbon atoms, R², R³, and R⁴ are methyl, and R⁵ is N-(2-aminoethyl)-3-aminopropyl group.

In another specific embodiment, R¹ is an alkyl group containing from about 30 to about 45 carbon atoms, R², R³, and R⁴ are methyl, and R⁵ is N-(2-aminoethyl)-3-aminopropyl group.

In aminosilicone (I), the value of x is within the range of 1 to about 2,000, about 10 to about 1,500, more preferably from about 50 to about 1500, from about 100 to about 1250, and even from about 500 to about 1,000. In aminosilicone (I), the value of y is within the range of 1 to about 50, 2 to about 40, 5 to about 30, 10 to about 25, or 15 to about 20.

The aminosilicone (I) generally has a viscosity of about 1,000 to about 5,000,000 mPa·s, about 2,000 to about 4,000,000 mPa·s, about 5,000 to about 3,000,000 mPa·s, about 10,000 to about 2,000,000 mPa·s, about 25,000 to about 1,000,000 mPa·s, or about 50,000 to about 500,000 mPa·s. The viscosity can be measured on a Brookfield viscometer LVDV with a spindle #4, at 0.3 rpm at 25° C.

The aminosilicone (I) has a nitrogen content of 0.01 to about 0.3% by weight, about 0.05 to about 0.25% by weight, or about 0.1 to about 0.2% by weight. The nitrogen content refers to the weight of nitrogen per weight of polymer and is expressed in weight percentage. If the amino content of the aminosilicone is too high, the benefit derived from the aminosilicone may decrease or negatively impact the coating.

The aminosilicone may be provided as an emulsion in the aqueous surface treating composition. That is, in one embodiment, the aminosilicone is emulsified to be an emulsion and then blended with the polymer resin emulsion to form the coating composition.

The aminosilicone containing emulsion can be prepared by any suitable method for forming an emulsion including, but not limited to, using an emulsion machine such as a colloid mill, a line mixer, a homomixer, a homogenizer, or an integrated emulsion machine having an anchor mixer and homomixer, or an anchor mixer and disper mixer.

In the preparation of the emulsion, a surfactant and water are used. As the surfactant, any of an anionic surfactant, a cationic surfactant, a nonionic surfactant and an amphoteric surfactant may be used, and they may be used alone or as a mixture of two or more.

Examples of suitable anionic surfactants include, but are not limited to, dodecylbenzenesulfonic acid, octylbenzenesulfonic acid, polyoxyethylene lauryl sulfate, lauryl sulfate, tetradecenesulfonic acid, hydroxytetradecenesulfonic acid, and sodium salt, potassium salt, triethanolamine salt thereof, and the like, and combinations of two or more thereof

Examples of cationic surfactants include, but are not limited to, lauryltrimethylammonium hydroxide, stearyltrimethylammonium hydroxide, dioctyldimethylammonium hydroxide, distearyldimethylammonium hydroxide, lauryltrimethylammonium chloride, stearyltrimethylammonium chloride, cetyltrimethylammonium chloride, dicocodimethylammonium chloride, di stearyldimethylammonium chloride, benzalkonium chloride, stearyldimethylbenzylammonium chloride, and the like, or combinations of two or more thereof. Other suitable cationic surfactants include amidoamine derivatives such as behenamidopropyl dimethylamine or esterquat based on long alkyl chain, for example behenoyl PG-trimonium chloride.

Examples of nonionic surfactants include, but are not limited to, polyoxyethylene lauryl ether, polyoxyethylene fatty acid ester, polyoxyethylene sorbitan fatty acid ester, sorbitan fatty acid ester, glycerine fatty acid ester, polyoxyethylene hardened castor oil, polyoxyethylene sorbitol fatty acid ester, polyoxyethylene alcohols based on high molecular mass saturated fatty alcohols, and the like, and combinations of two or more thereof. Other suitable nonionic surfactants are alkylpolyglucosides.

Examples of amphoteric surfactants include, but are not limited to, laurylamine oxide, lauryl betaine, cocamidopropyl betaine, and the like.

Some specific examples of nonionic surfactants include, but are not limited to, polyoxyethylene (6) lauryl ether, polyoxyethylene (7) cetyl ether, polyoxyethylene (20) stearyl ether, polyoxyethylene (3) octylphenyl ether, polyoxyethylene (18) nonylphenyl ether, polyethylene glycol monostearate (E014), polyethylene glycol distearate (E080), polyoxyethylene (20) sorbitan, polyoxyethylene (20) hardened castor oil, polyoxyethylene (20) sorbitan monolaurate, polyoxyethylene (20) sorbitan monopalmitate, polyoxyethylene (6) sorbitan monostearate, polyoxyethylene (20) sorbitan trioleate, polyoxyethylene (40) sorbitan tetraoleate, polyoxyethylene (15) glyceryl monooleate, polyoxyethylene (15) glyceryl monostearate, sorbitan monopalmitate, polyoxyethylene (10) behenyl ether, polyoxyethylene (10) phytosterol, polyoxyethylene (10) polyoxypropylene (4) cetyl ether, polyoxyethylene (5) stearylamine, polyoxyethylene (8) stearylpropylenediamine, polyoxyethylene (5) cetyl ether sodium phosphate, cetereath-n compounds, and the like, and combinations of two or more thereof. Among the nonionic surfactants, one having a HLB value of 6 to 20 is preferably used, since the stability of resulting emulsion is good.

The surfactant is generally provided within the range of about 1 to about 40% by weight of the whole emulsion, about 2 to about 20% by weight, about 3 to about 15% by weight, or about 5 to about 10% by weight. When less than about 1% by weight is used, it is difficult to disperse each component well, and when more than about 40% by weight is used, the stability of the emulsion becomes lowered. Water is provided as a dispersing medium and is generally within the range of about 20 to about 90% by weight of the whole emulsion, more preferably about 30 to about 80% by weight of the whole emulsion.

At the time of emulsification, by neutralizing the amino portion with an acid, the stability of the emulsion can be improved. The acids used at that time include organic acids such as acetic acid, lactic acid or glycolic acid, and inorganic acids such as hydrochloric acid, sulfuric acid or phosphoric acid.

In the surface treating composition, the aminosilicone is provided in an amount of from about 0.01 to about 10 wt. %, from about 0.025 to about 7.5 wt. %, from about 0.05 to about 5 wt. %, from about 0.1 to about 2.5 wt. %, or from about 0.5 to about 1 wt. % based on the total weight of the composition. In one embodiment, the aminosilicone is provided in an amount of from about 0.025 to about 0.5 wt. %, from about 0.05 to about 0.3 wt. % or from about 0.1 to about 0.2 wt. % based on the total weight of the composition. In another embodiment, the aminosilicone is provided in an amount of from about 1 to about 5 wt. %, from about 1.5 to about 4 wt. % or from about 2 to about 3 wt. % based on the total weight of the composition.

The polymer resin is not particularly limited and can be selected as desired for a particular purpose or intended application. The polymer resins are waterborne polymer resins. Examples of suitable polymer resins include, but are not limited to, acrylic resins, waterborne polyurethane resins, waterborne polyester resins, epoxy resins, alkyd resins, vinyl resins, carbohydrate-based waterborne latexes, protein-based waterborne latexes, and the like.

In an embodiment, the polymer resin comprises a latex polymer formed by emulsion polymerization of at least one ethylenically unsaturated monomer in water using surfactants and water soluble initiators. Typical ethylenically unsaturated monomers include, but are not limited to, vinyl monomers, acrylic monomers, acrylate monomers, methacrylic monomers, methacrylate monomers, acid-functional monomers, allylic monomers, and acrylamide monomers or a mixture of two or more thereof. In an embodiment particularly suitable for architectural applications, the waterborne organic resin(s) may be formed from vinyl monomers and/or acrylic monomers. Suitable vinyl monomers include, but are not limited to, vinyl esters, vinyl aromatic hydrocarbons, vinyl aliphatic hydrocarbons, vinyl alkyl ethers, or a mixture of two or more thereof. Examples of vinyl esters that may be used include, but are not limited to, vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates, or a combination or two or more thereof. Examples of vinyl aromatic hydrocarbons that may be used include, but are not limited to, styrene, methyl styrenes and other lower alkyl styrenes, chlorostyrene, vinyl toluene, vinyl naphthalene, divinyl benzene, or a combination of two or more thereof. Examples of vinyl aliphatic hydrocarbons that may be used include, but are not limited to, vinyl chloride and vinylidene chloride as well as alpha olefins such as ethylene, propylene, isobutylene, hexylene and octylene, as well as conjugated dienes such as, but not limited to, 1,3 butadiene, methyl-2-butadiene, 1,3-piperylene, 2,3-dimethyl butadiene, isoprene, cyclohexadiene, cyclopentadiene and dicyclopentadiene or a mixture of two or more thereof. Examples of vinyl alkyl ethers that may be used include, but are not limited to, methyl vinyl ether, isopropyl vinyl ether, n-butyl vinyl ether and isobutyl vinyl ether or a mixture of two or more thereof. Acrylic monomers suitable for use in the present invention include any compounds having acrylic functionality such as, but not limited to, alkyl acrylates, acrylic acids, as well as aromatic derivatives of acrylic acid, acrylamides and acrylonitrile or a mixture of two or more thereof. Methacrylic monomers suitable for use in the present invention include any compounds having methacrylic functionality such as, but not limited to, alkyl methacrylates, methacrylic acids, as well as aromatic derivatives of methacrylic acid and methacrylamides or a mixture of two or more thereof. Typically, the alkyl acrylate monomers (also referred to herein as “alkyl esters of acrylic acid”) and methacrylate monomers (also referred to herein as “alkyl esters of methacrylic acid”) will have an alkyl group containing from 1 to 12, preferably about 1 to 5, carbon atoms per molecule.

Suitable acrylic monomers include, but are not limited to, methyl acrylate, ethyl acrylate, butyl acrylate, propyl acrylate, 2-ethyl hexyl acrylate, decyl acrylate, isodecyl acrylate and neopentyl acrylate, or a mixture of two or more thereof. Aryl acrylate monomers include, but are not limited to, phenyl acrylate and tolyl acrylate, or a mixture thereof. Aralkyl acrylate monomers include, but are not limited to, benzyl acrylate and phenethyl acrylate, or a mixture thereof. Cycloalkyl acrylate monomers include, but are not limited to, cyclohexyl acrylate, isobornyl acrylate, 1-adamantyl acrylate, or a mixture of two or more thereof. Various reaction products such as butyl, phenyl, and cresyl glycidyl ethers reacted with acrylic acid, hydroxyl alkyl acrylates, such as hydroxyethyl and hydroxypropyl acrylates, amino acrylates, as well as acrylic acids such as acrylic acid, ethacrylic acid, alpha-chloroacrylic acid, alpha-cyanoacrylic acid, crotonic acid, beta-acryloxy propionic acid, and beta-styryl acrylic acid, or a mixture of two or more thereof can be used as monomers.

Suitable methacrylic monomers include, but are not limited to, methyl methacrylate, ethyl methacrylate, butyl methacryl ate, propyl methacrylate, 2-ethyl hexyl methacrylate, decyl methacrylate, isodecyl methacrylate and neopentyl methacrylate, or a mixture of two or more thereof. Aryl methacrylate monomers include phenyl methacrylate and tolyl methacrylate, or a mixture thereof. Aralkyl methacrylate monomers include benzyl methacrylate and phenethyl methacrylate, or a mixture thereof. Cycloalkyl methacrylate monomers include cyclohexyl methacrylate, isobornyl methacrylate, 1-adamantyl methacrylate, or a mixture of two or more thereof. Various reaction products such as butyl, phenyl, and cresyl glycidyl ethers reacted with methacrylic acid, hydroxyl alkyl methacrylates, such as hydroxyethyl and hydroxypropyl methacrylates, amino methacrylates, as well as methacrylic acids such as methacrylic acid, and beta-styryl methacrylic acid, or a mixture of two or more thereof can be used as monomers.

The polymer resin emulsion may be prepared using any of the well-known free-radical emulsion polymerization techniques used to formulate latex polymers. Polymerization techniques suitable for use herein are taught in U.S. Pat. No. 5,486,576, which is incorporated herein by reference in its entirety.

In one embodiment, the polymer resin emulsion is a latex polymer emulsion. Conventional latex emulsions include those prepared by polymerizing at least one ethylenically unsaturated monomer in water using surfactants and water-soluble initiators. Typical ethylenically unsaturated monomers include vinyl monomers, acrylic monomers, allylic monomers, acrylamide monomers and mono- and dicarboxylic unsaturated acids. Suitable vinyl esters include, but are not limited to, vinyl acetate, vinyl propionate, vinyl butyrates, vinyl isopropyl acetates, vinyl neodeconate and similar vinyl esters; vinyl halides include vinyl chloride, vinyl fluoride and vinylidene chloride; vinyl aromatic hydrocarbons include styrene, α-methyl styrene, and similar lower alkyl styrenes. Suitable acrylic monomers include monomers such as lower alkyl esters of acrylic or methacrylic acid having an alkyl ester portion containing between 1 to 12 carbon atoms as well as aromatic derivatives or acrylic and methacrylic acid. Useful acrylic monomers include, but are not limited to, for example, acrylic and methacrylic acid, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, and benzyl acrylate and methacrylate.

Other useful polymer resin emulsions include, but are not limited to, polyurethane emulsions, polyester emulsions, and epoxy emulsions.

In an embodiment, the polymer resin emulsion comprises from about 25 to 99 weight percent water and from about 1 to about 75 weight percent organic resin and surfactant, from about 30 to about 75 weight percent water and from about 25 to about 70 weight percent organic resin and surfactant, or from about 40 to 60 weight percent water and from about 40 to about 60 weight percent organic resin and surfactant wherein the weight percents are based upon the total weight of the organic resin, surfactant, and water.

The aqueous composition may contain one or more optional additives to impart a desirable property or effect to the surface treating composition. Examples of suitable additives include, but are not limited to, fillers (inorganic fillers, organic fillers), pigments, wetting agents, dispersing agents, rheology modifiers agents, preservatives, UV stabilizers, antifoam agents, coalescent agents, crosslinking agents, pH adjusting agents (base or acids), buffering agents, hydrophobizing agents such as waxes, natural waxes or synthetic waxes. The composition can contain nanoparticles, nano sized titanium oxide, colloidal silica, fumed silica, carbonaceous nano-sized fillers (carbon black, fullerene, carbon nanotubes, graphene), cellulose nanocrystals or other cellulose nanoparticles.

Fillers may be provided in an amount of from 0 to about 80 weight percent, from about 0.1 weight percent to about 80 weight percent, from about 0.5 to about 50 weight percent, or from about 1 to about 25 weight percent based on the total weight of the composition.

Pigments may be provided in an amount of from 0 to about 80 weight percent, from about 0.1 weight percent to about 80 weight percent, from about 0.5 to about 50 weight percent, or from about 1 to about 25 weight percent based on the total weight of the composition.

Wetting agents may be provided in an amount of from 0 to about 5 weight percent, from about 0.01 weight percent to about 5 weight percent, from about 0.05 to about 2.5 weight percent, or from about 0.1 to about 1 weight percent based on the total weight of the composition.

Dispersing agents may be provided in an amount of from 0 to about 5 weight percent, from about 0.01 weight percent to about 5 weight percent, from about 0.05 to about 2.5 weight percent, or from about 0.1 to about 1 weight percent based on the total weight of the composition.

Rheology agents may be provided in an amount of from 0 to about 10 weight percent, from about 0.01 weight percent to about 10 weight percent, from about 0.1 to about 5 weight percent, or from about 0.5 to about 2.5 weight percent based on the total weight of the composition.

Preservatives may be provided in an amount of from 0 to about 3 weight percent, from about 0.001 weight percent to about 3 weight percent, from about 0.01 to about 2 weight percent, or from about 0.1 to about 1 weight percent based on the total weight of the composition.

UV stabilizers may be provided in an amount of from 0 to about 5 weight percent, from about 0.001 weight percent to about 5 weight percent, from about 0.01 to about 2.5 weight percent, or from about 0.1 to about 1 weight percent based on the total weight of the composition.

Antifoam agents may be provided in an amount of from 0 to about 3 weight percent, from about 0.01 weight percent to about 3 weight percent, from about 0.05 to about 2 weight percent, or from about 0.1 to about 1 weight percent based on the total weight of the composition.

Coalescent agents may be provided in an amount of from 0 to about 20 weight percent, from about 0.01 weight percent to about 20 weight percent, from about 0.1 to about 15 weight percent, or from about 1 to about 10 weight percent based on the total weight of the composition.

Crosslinking agents may be provided in an amount of from 0 to about 5 weight percent, from about 0.005 weight percent to about 5 weight percent, from about 0.05 to about 2.5 weight percent, or from about 0.5 to about 1 weight percent based on the total weight of the composition.

pH adjusting agents (base or acids) may be provided in an amount of from 0 to about 5 weight percent, from about 0.01 weight percent to about 5 weight percent, from about 0.1 to about 2.5 weight percent, or from about 0.5 to about 1 weight percent based on the total weight of the composition.

Buffering agents may be provided in an amount of from 0 to about 5 weight percent, from about 0.01 weight percent to about 5 weight percent, from about 0.1 to about 2.5 weight percent, or from about 0.5 to about 1 weight percent based on the total weight of the composition.

Hydrophobizing agents may be provided in an amount of from 0 to about 10 weight percent, from about 0.1 weight percent to about 10 weight percent, from about 0.5 to about 5 weight percent, or from about 1 to about 2.5 weight percent based on the total weight of the composition.

Nanoparticles may be provided in an amount of from 0 to about 50 weight percent, from about 0.1 weight percent to about 50 weight percent, from about 1 to about 25 weight percent, or from about 5 to about 10 weight percent based on the total weight of the composition.

The compositions can be prepared by mixing the amino silicone emulsion with the polymer resin emulsion along with any other additives as may be desired for the coating.

The surface treating compositions of this invention can be applied to a desired surface or portion of a surface of a substrate using most any application techniques or tools. The compositions can be applied by spray techniques, brushing with fiber-based rollers, using roll coating equipment, and the like. The surface treating compositions may be provided or employed in a number of different treatment applications. For example, the compositions may find application as a coating (e.g., as a paint, protective coating, etc.), an adhesive, a sealant, and the like. The substrates to which the compositions of this invention can be applied include wood-based substrates, drywall, plasterboard, cement, concrete, wallpaper, previously coated surfaces, stucco, leather, plastic-based surfaces, plastic film, polyolefin based substrate, paper, cardboard, metal, glass, ceramics, tiles, stones, laminates, composite materials and the like. The compositions are suitable for use in interior applications, but exterior applications can also be considered. The coatings can be used in a variety of applications including, but not limited to, architectural applications, automotive applications, electronic applications, wood applications, marine applications, packaging applications, coil applications, and the like.

Aspects of the technology may be further understood with reference to the following Examples. The Examples are primarily for the purpose of demonstrating aspects of the technology and are not intended to limit the technology to those specific embodiments illustrated by the Examples.

### EXAMPLES

Paint preparation: Paint compositions were prepared with standard mixing techniques described in the literature (Organic Coatings: Science and technology, Z. Wicks, F. Jones and P. Pappas, Ed Wiley-Interscience Publication, 1998, Chapter 31, Architectural Coatings, which is incorporated herein by reference in its entirety).

Coating sample preparation: The paints were applied on a glass slide or a steel plate with a bird applicator with a 75 micron gap and dried at room temperature for one week. The plate and the steel plate were cleaned with IPA prior to the paint application.

Static water contact angle: The water contact angle was measured with a VCA Optima instrument. A four microliter Millipore water droplet was produced by a Hamilton syringe and deposited on the paint coating. A movie was recorded to capture the droplet after contact. The reported contact angle reported is the average of the contact angle of three droplets.

Dynamic coefficient of friction: The dynamic coefficient of friction was measured using a CSM tribometer, using a linear reciprocal stroke with amplitude of 0.5 mm, a stainless steel ball (5 mm diameter), a 2 N load, and a sliding speed of 1 cm/s.

Dynamic contact angle: Water dynamic contact angle and oil dynamic contact angle were measured on a Thermo Cahn DCA 322 microbalance. Paint was applied with a sponge applicator on both sides of a leneta black scrub test panel cut to a rectangular size of 1 inch per 1.5 inches. The dry paint film thickness was around 50 microns. The speed and the total depth of the sample immersion were 80 microns/sec and 8 mm respectively. The initial surface tension of water before the water dynamic contact angle was measured with a platinum Wilhelmy plate and was equal to 72 mN/m. The surface tension of the water after immersion of the sample was measured after the immersion and withdrawal of the paint sample to quantify the leaching of surfactants or surface-active materials into the water. The oil used for oil contact angle was soybean oil Agri-Pure 25 from Cargill. The surface tension of soybean oil was 33 mN/m.

The crater formation was visually assessed.

### Example I

### Aqueous Acrylic Paints

Aqueous paint compositions are shown in Table 1. Hydroplat WE 3111 is a wetting agent from BASF. Dispex CX4230, Dispex AA4144, are dispersing agents from BASF. Foamstar ST2438, Foamstar ST 2420, are antifoams from BASF. Rheovis PU1191, Rheovis PU1331, are polymeric rheology modifiers from BASF. Attagel 50 is a clay-based rheology modifier. Titanium oxide pigments Ti-Pure R902 and R746 are from Dupont. Minex-7 is from Unimin Specialty Minerasl Inc. Texanol is a coalescent agent from Eastman. Proxel BD20 is preservative from Lonza. Acronal 4230 PLUS is an all-acrylic latex with a minimum film formation temperature of 6° C. with 60% solid is from BASF.

The comparative silicone emulsion is a 50% solids emulsion of a dimethiconol silicone gum emulsion produced by emulsion polymerization, stabilized by sodium laurate sulfate and sodium laurate ether sulfate wherein the viscosity of the silicone gum ranges from 350,000 to 700,000 mPa·s. The viscosity was measured on a Brookfield viscometer LVDV with a spindle #4, at 0.3 rpm at 25° C.

Silicone Emulsion A is a 45% weight percent solids emulsion of an alkyl aminosilicone, stabilized by nonionic surfactants. The alkyl aminosilicone modified at both ends is represented by formula (I) where x is 650, y is 3.5, R1 is an alkyl group having 16 to 18 carbon atoms, R2, R3, and R4 are each methyl, and R5 is a N-2 aminoethyl 3 aminopropyl group. The aminosilicone was emulsified with a mixture of nonionic surfactants selected from ceteareth-7 and ceteareth 21. The aminosilicone had a viscosity of from about 5000 to about 20,000 mPa·s. The viscosity was measured on a Brookfield viscometer LVC, with a spindle #4 at 30 rpm.

TABLE 1

| Chemical Name | Comp | | | Comp | Comp | Comp | | | Comp | Comp |
|---|---|---|---|---|---|---|---|---|---|---|
| or Tradenames | 0 | Ex 1 | Ex 2 | 1 | 2 | 3 | Ex 3 | Ex 4 | 4 | 5 |
| A (GRIND) | g | g | g | g | g | g | g | g | g | g |
| Water | 15.70 | 15.54 | 15.23 | 15.54 | 15.23 | 9.09 | 9.00 | 8.82 | 9.00 | 8.82 |
| Proxel BD 20 preservative | 0.1 | 0.1 | 0.1 | 0.1 | 0.1 | 0.27 | 0.27 | 0.26 | 0.27 | 0.26 |
| Ethylene Glycol | 1.58 | 1.56 | 1.53 | 1.56 | 1.53 | 0.82 | 0.81 | 0.79 | 0.81 | 0.79 |
| Ammonium Hydroxide | | | | | | 0.18 | 0.18 | 0.18 | 0.18 | 0.18 |
| Hydroplat WE 3111 alcohol | 0.31 | 0.31 | 0.30 | 0.31 | 0.30 | | | | | 0 |
| ethoxylate | | | | | | | | | | |
| Dispex CX 4230 dispersant | | | | | | 0.55 | 0.54 | 0.53 | 0.54 | 0.53 |
| Dispex AA4144 polyacrylic | 0.63 | 0.63 | 0.61 | 0.63 | 0.61 | | | | | 0 |
| acid | | | | | | | | | | |
| Foamstar ST2438 antifoam | 0.16 | 0.15 | 0.15 | 0.15 | 0.15 | | | | | 0 |
| Foamstar ST 2420 antifoam | | | | | | 0.18 | 0.18 | 0.18 | 0.18 | 0.18 |
| Natrosol 250 HBR PA | | | | | | 0.09 | 0.09 | 0.09 | 0.09 | 0.09 |
| cellulose | | | | | | | | | | |
| Rheovis PU1191 | 0.21 | 0.21 | 0.20 | 0.21 | 0.20 | | | | | 0 |
| polyurethane | | | | | | | | | | |
| Minex 7 nepheline syenite | | | | | | 9.09 | 9.00 | 8.82 | 9.00 | 8.82 |
| TiO₂ Ti-Pure R902 | 25.12 | 24.87 | 24.36 | 24.87 | 24.36 | | | | | 0 |
| Attagel 50 clay | 0.31 | 0.31 | 0.30 | 0.31 | 0.30 | 0.36 | 0.36 | 0.35 | 0.36 | 0.35 |
| | | | | | | | | | | 0 |
| B LETDOWN | | | | | | | | | | 0.00 |
| Water | 5.24 | 5.18 | 5.08 | 5.18 | 5.08 | 13.45 | 13.32 | 13.05 | 13.32 | 13.05 |
| Foamstar ST 2420 antifoam | | | | | | 0.27 | 0.27 | 0.26 | 0.27 | 0.26 |
| Ti-Pure R746 Titanium | | | | | | 30.00 | 29.70 | 29.10 | 29.70 | 29.10 |
| oxide | | | | | | | | | | |
| Acronal 4230 PLUS acrylic | 47.09 | 46.62 | 45.68 | 46.62 | 45.68 | 31.82 | 31.50 | 30.86 | 31.50 | 30.86 |
| latex | | | | | | | | | | |
| Texanol trimethyl | 0.67 | 0.66 | 0.65 | 0.66 | 0.65 | 0.73 | 0.72 | 0.71 | 0.72 | 0.71 |
| pentanediol monoisobutyrate | | | | | | | | | | |
| Water | 2.90 | 2.87 | 2.81 | 2.87 | 2.81 | 0.55 | 0.54 | 0.53 | 0.54 | 0.53 |
| Rheovis PE 1331 | | | | | | 1.82 | 1.80 | 1.76 | 1.80 | 1.76 |
| hydrophobed polyethylene | | | | | | | | | | |
| glycol | | | | | | | | | | |
| Rheovis PU 1191 | | | | | | 0.73 | 0.72 | 0.71 | 0.72 | 0.71 |
| polyurethane | | | | | | | | | | |
| Silicone emulsion A | | 1 | 3 | | | | 1 | 3 | | |
| Comparative emulsion | | | | 1 | 3 | | | | 1 | 3 |
| Total weight | 100 | 100 | 100 | 100 | 100 | 100 | 100 | 100 | 100 | 100 |
| Static water contact angle | 74 | 104 | 112 | 91 | 90 | 93 | 105 | 111 | 93 | 92 |
| (degree) | | | | | | | | | | |
| Dynamic Coefficient of | 0.30 | 0.51 | 0.16 | 0.39 | 0.06 | 0.34 | 0.41 | 0.27 | 0.37 | 0.15 |
| friction | | | | | | | | | | |
| Gloss 20° | 4.4 | — | 4.6 | — | 5.8 | 1.9 | — | 1.5 | — | 1.5 |
| Gloss 60° | 33.6 | — | 35.1 | — | 37 | 6.2 | — | 7.3 | — | 6.8 |
| Crater formation | No | No | No | No | Yes | No | No | No | No | Yes |

The alkyl terminated aminosilicone provides an increased hydrophobicity compared to the silicone gum emulsion. At a concentration of 3 wt. %, the alkyl terminated aminosilicone emulsion provides both reduced friction and increased hydrophobicity without producing film defects or significantly affecting gloss.

### Example II

### Clear Acrylic Coatings

The acrylic compositions shown in Table 2 were applied on a glass slide with a bird applicator and dried for one week at room temperature. Rhoplex AC261 is an all acrylic latex with a minimum film formation temperature of 16° C. from Dow. Colloidal silica Nalco1050 has a particle size of 20 nm. Silicone emulsion A and Comparative emulsion were described in EXAMPLE I.

TABLE 2

| | | | | | Comp | Comp | Comp | Comp | |
|---|---|---|---|---|---|---|---|---|---|
| | Comp 6 | Ex 5 | Ex 6 | Ex 7 | 7 | 8 | 9 | 10 | Ex 8 |
| | wt % | wt % | wt % | wt % | wt % | wt % | wt % | wt % | wt % |
| Rhoplex AC261 | 46.1 | 46.1 | 46.1 | 46.1 | 46.1 | 46.1 | 46.1 | 46.1 | 46.1 |
| Texanol | 1.5 | 1.5 | 1.5 | 1.5 | 1.5 | 1.5 | 1.5 | 1.5 | 1.5 |
| Silicone emulsion A | | 1.0 | 2.0 | 3.0 | | | | | 0.3 |
| Comparative emulsion | | | | | 1.0 | 2.0 | 3.0 | | |
| colloidal silica Nalco1050 | | | | | | | | 2.0 | 2.0 |
| water | 52.4 | 51.4 | 50.4 | 49.4 | 51.4 | 50.4 | 49.4 | 50.4 | 50.1 |
| Total | 100 | 100 | 100 | 100 | 100 | 100 | 100 | 100 | 100 |
| Static Water Contac Angle | 78 | 104 | 112 | 114 | 94 | 99 | 100 | — | — |
| (degree) | | | | | | | | | |
| Dynamic Coefficient of | 0.42 | 0.07 | 0.03 | 0.03 | 0.05 | 0.03 | 0.03 | 0.59 | 0.37 |
| friction | | | | | | | | | |

The alkyl terminated aminosilicone provides an increased hydrophobicity compared to the comparative emulsion. Even at concentration of 0.3 wt. %, the silicone emulsion A reduces significantly the dynamic coefficient of friction (Example 8) compared to the comparative coating (Comp 10). EXAMPLE III: Dynamic contact angle and surfactant leaching test Paints of EXAMPLE I (Comp 3, Ex 4, Comp 5) were applied and dried on Leneta black scrub test panel (Form P121-10N, black plastic-vinyl chloride/acetate copolymer). The water dynamic advancing contact angle and the soybean oil dynamic contact angle of the paint films were measured to assess hydrophobicity and oleophobicity. The leaching of surface-active materials from the paint to the water phase was assessed by measuring water surface tension before and after immersion of the paint sample. The lower the surface tension is, the worse the surfactant leaching (reference: P. Santos, et al., Low-VOC Coalescents. Coating World - Technical Paper, p, 2019, https://www.coatingsworld.com/issues/2019-2008-2001/view_technical-papers /low-voc-coalescents)

TABLE 3

| | Comp 11 | Ex 9 | Ex 10 |
|---|---|---|---|
| Paint composition | Paint of | Paint of | Paint of |
| | Comp 3 | Ex 4 | Comp 5 |
| Amount of silicone emulsion A in paint | 0 | 3 | 0 |
| wt. % | | | |
| Amount of comparative emulsion in paint | 0 | 0 | 3 |
| wt. % | | | |
| Water advancing contact angle (degree) | 72.0 | 92.5 | 76.6 |
| Water surface tension after measurement | 59.7 | 59.5 | 53.6 |
| mN/m | | | |
| Oil advancing contact angle (degree) | 34.7 | 68.9 | 43.9 |

The water advancing contact angle with the paint containing the alkyl-terminated aminosilicone is higher than with the paint containing the comparative emulsion.

The comparative paint (Comp 11) leaches surface-active materials into the water as indicated by the lowering of surface tension from the initial value of clean water 72 mN/m.

The alkyl-terminated aminosilicone does not cause any significant additional release of surface-active material whereas the comparative silicone emulsion reduces further surface tension of water.

The increase of oil advancing contact angle with the alkyl-terminated aminosilicone is significantly higher than with the comparative emulsion, indicating a better oleophobicity effect with the alkyl terminated aminosilicone emulsion than with the comparative emulsion.

Example III: Aqueous acrylic paints

Aqueous paint compositions are shown in Table 4. Hydroplat WE 3105 is a wetting agent from BASF. Dispex AA4146 is a dispersing agent from BASF. Foamstar ST2410 are antifoams from BASF. Rheovis PU1250 is a polymeric rheology modifier from BASF. Titanium oxide pigment Ti-Pure R902 is from Dupont. Texanol is a coalescent agent from Eastman. IPEL BP-503 is preservative from IPEL. Acronal 4670 PLUS is an all acrylic latex with a minimum film formation temperature of 10° C. with 50% solid is from BASF.

The comparative silicone emulsion is a 50% solids emulsion of a dimethiconol silicone gum emulsion produced by emulsion polymerization, stabilized by sodium laurate sulfate and sodium laurate ether sulfate wherein the viscosity of the silicone gum ranges from 350,000 to 700,000 mPa·s. The viscosity was measured on a Brookfield viscometer LVDV with a spindle #4, at 0.3 rpm at 25° C.

Silicone Emulsion A is a 45% weight percent solids emulsion of an alkyl aminosilicone, stabilized by nonionic surfactants. The alkyl aminosilicone modified at both ends is represented by formula (I) where x is 650, y is 3.5, R1 is an alkyl group having 16 to 18 carbon atoms, R2, R3, and R4 are each methyl, and R5 is a N-2 aminoethyl 3 aminopropyl group. The aminosilicone was emulsified with a mixture of nonionic surfactants selected from ceteareth-7 and ceteareth 21. The aminosilicone had a viscosity of from about 5000 to about 20,000 mPa·s. The viscosity was measured on a Brookfield viscometer LVC, with a spindle #4 at 30 rpm.

The scrub resistance test was performed according to ASTM2486 (method A), test was done in duplicate.

Blocking resistance test: Paint was applied to a dull black plastic panel (P-121-10N from Leneta Co.) with a 7 mil clearance film applicator and dried for seven days at room temperature. The plastic panel was cut into squares of 2 in by 2 in. Two cut sections were placed with the paint surfaces face to face. The face-to-face specimen was placed in a 50° C. oven. A cylindrical weight of 1000 grams (radius =2 cm) was placed on top of the specimen and kept at 50° C. for 2 minutes. The contact pressure on the specimens was about 80 gram/cm². After cooling, the face-to-face specimen was peeled apart. The panel was rated based on visual examination. The degree of blocking resistance was rated on a scale of 10 to 0. The block resistance ratings are described in the ASTM D4946. The degree of seal was the estimated area on the specimens where the paint of surfaces adhere with each other. A rating of 10 indicated no tack and no seal. A rating of 1 indicated a degree of seal from 50% to 75%. The experiment was performed in triplicate.

Surfactant leaching test method: Paint was applied to a dull black plastic panel (P-121-10N from Leneta Co.) with a 7 mil clearance film applicator and dried for two hours at room temperature. Three water droplets of about 0.1 cc in volume each were placed on top of the test paint and allowed to stand for 10 minutes. The panel was lifted into a vertical position, allowing the droplets to run down and then dried overnight vertically at room temperature. The panel was rated based on visual examination.

TABLE 4

| | Comp 12 | Comp 13 | Ex 11 |
|---|---|---|---|
| | wt % | wt % | wt % |
| Part A (GRIND) | | | |
| DI Water | 18.80 | 18.25 | 18.25 |
| Hydropalat WE 3105 † | 0.20 | 0.19 | 0.19 |
| Dispex AA 4146 † | 0.30 | 0.29 | 0.29 |
| Foamstar ST 2410 † | 0.25 | 0.24 | 0.24 |
| Ammonium | 0.45 | 0.44 | 0.44 |
| (solution of 25%) | | | |
| R902 † | 22.00 | 21.36 | 21.36 |
| butylene glycol | 1.00 | 0.97 | 0.97 |
| Texanol † | 0.50 | 0.49 | 0.49 |
| Foamstar ST 2410 † | 0.05 | 0.05 | 0.05 |
| DI water | 9.30 | 9.03 | 9.03 |
| IPEL BP- 503 † | 0.25 | 0.24 | 0.24 |
| Part B (LETDOWN) | | | |
| ACRONAL PLUS 4670 | 46.00 | 44.66 | 44.66 |
| Silicone emulsion A | | | 2.91 |
| Comparative emulsion | | 2.91 | |
| Rheovis PU 1250 † | 0.90 | 0.87 | 0.87 |
| | 100.0 | 100.0 | 100.0 |
| Scrub resistance (cycles) | 719 | 370 | 734 |
| ASTM 2486 trial 1 | | | |
| Scrub resistance (cycles) | 914 | 442 | 774 |
| ASTM 2486 trial 2 | | | |
| Blocking resistance test | 1 | 10 | 10 |
| (rating) | | | |
| Surfactant leaching test | Large | Small | None or |
| | visible water | visible water | minimal water |
| | streaking | streaking | streaking |

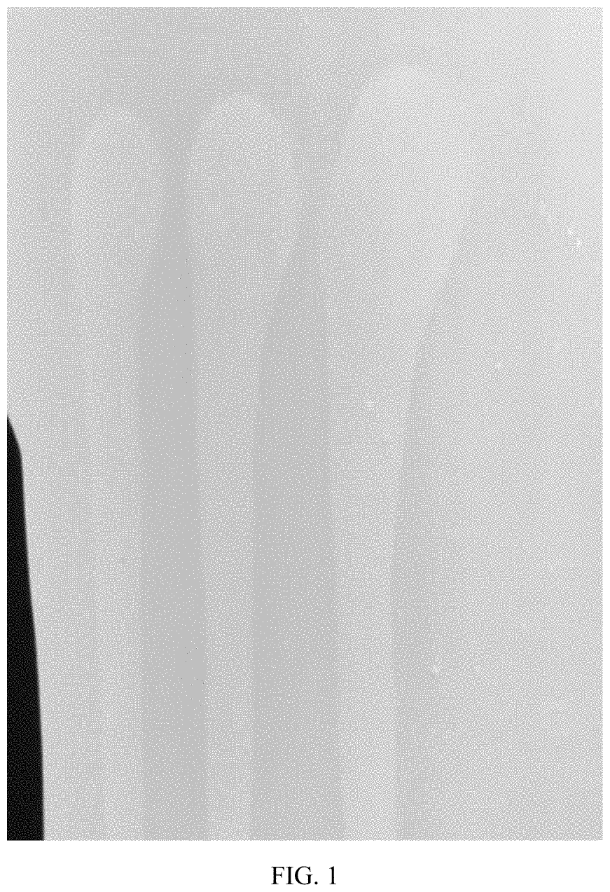

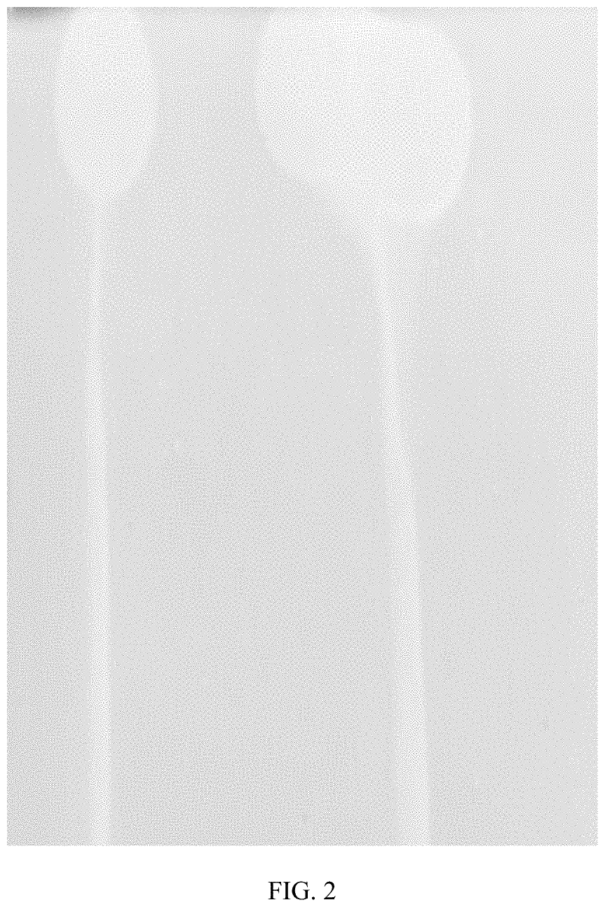

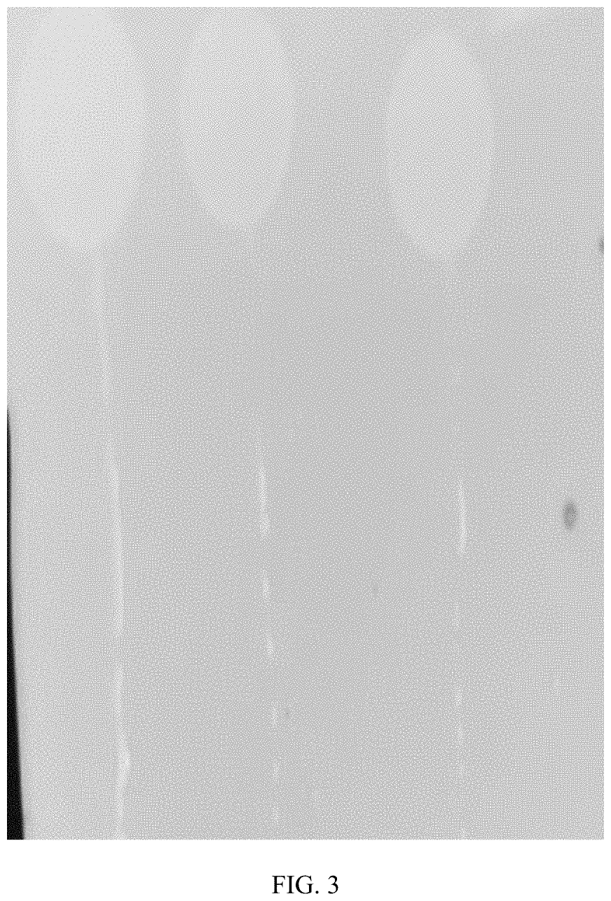

At a concentration of 2.9 wt. %, the alkyl terminated aminosilicone emulsion provided an increased block resistance (Ex. 11) compared to the base paint with no silicone (Comp 12). In addition, the example paint with alkyl terminated aminosilicone emulsion (Ex 11) provided a much lower surfactant leaching than the base paint (Comp 12) and the comparative paint with the silicone gum emulsion (Comp 13). FIGS. 1 to 3 are photographs of the paint panels used in the surfactant leaching test. FIG. 1 is the panel with Comparative 12, which shows large visible water steaking. FIG. 2 is the panel for Comparative 13, which shows small visible water streaking. FIG. 3 is the Example 11 panel showing minimal water streaking. In addition, the alkyl terminated aminosilicone emulsion did not decrease the paint scrub resistance significantly whereas the comparative silicone gum emulsion decreased scrub resistance very significantly.

### Example IV

### Polyurethane Dispersion Clear Coat

The clear-coat composition is shown in Table 5. Bayhydrol® UH 2953/1 is an aliphatic, fatty acid-modified, anionic polyurethane dispersion with a solids weight of 34.5% produced by Covestro. Di(propylene glycol) propyl ether or Dowanol DPnP is a coalescent agent from Dow Chemical Company. BYK 346 is a wetting agent from BYK. BYK 028 is a defoamer from BYK. AquaflowTM NHS 300 is a rheology modifier by Ashland.

The composition was prepared with an IKA Labortechnik RW16 Basic overhead mixer. The water and coalescent solvent were premixed under low mixing speeds (about 100 RPM). The water/coalescent premix, the polyurethane dispersion, the wetting agent, the defoamer, the silicone emulsion, the rheology modifier and additional water were added to the main mixing vessel and mixed together for 15 minutes under medium speeds (about 600 RPM). Then the composition was mixed under high mixing speeds (about 1200 RPM) for 5 minutes. Compositions of Example IV (Comp 14, Ex 12) were applied on a glass slide using a film applicator to form a 10 mil thick wet film and dried. The static water contact angle values in Table 5 is an average of 5 measurements.

TABLE 5

| | Comp 14 | Ex 12 |
|---|---|---|
| Chemical name or tradename | g | g |
| Bayhydrol UH 2593/1 | 68.03 | 66.11 |
| Water | 21.31 | 21.91 |
| Glycol Ether DPnP | 6.62 | 6.50 |
| Silicone Emulsion A | 0 | 1.50 |
| BYK 346 | 0.15 | 0.15 |
| BYK 028 | 0.86 | 0.83 |
| Aquaflow NHS 300 | 3.03 | 3.00 |
| Total weight | 100 | 100 |
| Static Water Contact Angle | 88 | 106 |
| (degree) | | |

The example formulation with the alkyl terminated aminosilicone (Ex 12) showed an increased hydrophobicity compared to the comparative formulation (Comp 14), as indicated by the high value of water contact angle (106°).

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a coating composition. Modifications may occur to those skilled in the art and to those who may make and use the invention. The disclosed embodiments are merely for illustrative purposes and not intended to limit the scope of the invention or the subject matter set forth in the claims.

What is claimed is:

1. An aqueous surface treating composition comprising:
(a) a polymer resin; and
(b) an aminosilicone material selected from a compound of formula (I):
MDₓD′_{y}M (I)
wherein
M=R¹R²₂SiO_{1/2},
D=R³₂SiO_{2/2}, and
D′=R⁴R⁵SiO_{2/2}, and
where R¹ is an alkyl group having 12 to about 50 carbon atoms; R², R³, and R⁴ are each independently selected from a substituted or un-substituted hydrocarbon group having 1 to about 20 carbon atoms; R⁵ is an aminoalkyl or diaminoalkyl group —R⁶—NR⁷R⁸ where R⁶ is a divalent alkylene with 2-12 carbon atoms, R⁷ is H or an alkyl group with 1 to 6 carbon atoms, and R⁸ is H, an alkyl group with 1 to 6 carbon atoms or —R⁹NH₂ where R⁹ is an alkylene group with 2 to 12 carbon atoms; x has a value of 1 to about 2,000; and y has a value of 1 to about 50.

2. The aqueous surface treating composition of claim 1, wherein R², R³, and R⁴ are each independently selected from a substituted or un-substituted hydrocarbon group having 1 to 6 carbon atoms.

3. The aqueous surface treating composition of claim 1, wherein R², R³, and R⁴ are each independently selected from methyl, ethyl, butyl, or hexyl.

4. The aqueous surface treating composition of claim 1, wherein R², R³, and R⁴ are each independently selected from a C4-C20 cycloalkyl group, an alkoxy, and a C6-C20 aryl group.

5. The aqueous surface treating composition of claim 1, wherein R², R^{3,} and R⁴ are each independently selected from an alkyl group or an aryl group.

6. The aqueous surface treating composition of claim 1, wherein R², R^{3,} and R⁴ are each independently selected from methyl or phenyl.

7. The aqueous surface treating composition of claim 1, wherein R⁵ in the aminosilicone material of the compound of formula (I) is a 3-aminopropyl group and/or a N-(2-aminoethyl)-3-aminopropyl group.

8. The aqueous surface treating composition of claim 1, wherein R¹ is an alkyl group containing from about 15 to about 20 carbon atoms; R², R³, and R⁴ are methyl; and R⁵ is a N-(2-aminoethyl)-3-aminopropyl group.

9. The aqueous surface treating composition of claim 1, wherein R¹ is an alkyl group containing from about 30 to about 45 carbon atoms; R², R³ , and R⁴ are methyl; and R⁵ is a N-(2-aminoethyl)-3-aminopropyl group.

10. The aqueous surface treating composition of claim 1, wherein the value of x is from about 10 to about 1,500, and the value of y is from about 2 to about 40.

11. The aqueous surface treating composition of claim 1, wherein the aminosilicone has a viscosity at 25° C. of about 1,000 to about 5,000,000 mPa·s.

12. The aqueous surface treating composition of claim 1, wherein the aminosilicone has a nitrogen content of 0.01 to about 0.3% by weight.

13. The aqueous surface treating composition of claim 1, wherein the aminosilicone material is an aminosilicone emulsion comprising the aminosilicone material and a surfactant.

14. The aqueous surface treating composition of claim 13, wherein the surfactant is selected from the group consisting of an anionic surfactant, a cationic surfactant, a nonionic surfactant, an amphoteric surfactant, and a combination thereof.

15. The aqueous surface treating composition claim 1, wherein the polymer resin is selected from an acrylic resin, a waterborne polyurethane resin, a waterborne polyester resin, an epoxy resin, an alkyd resin, a vinyl resin, a carbohydrate-based waterborne latex, a protein-based waterborne latex, or a combination of two or more thereof

16. The aqueous surface treating composition of claim 1, wherein the polymer resin is a polymer resin emulsion.

17. The aqueous surface treating composition of claim 1, wherein the aminosilicone material is present in an amount of from about 0.01 to about 10 wt. % based on the total weight of the composition.

18. The aqueous surface treating composition of claim 1, wherein the aminosilicone material is present in an amount of from about 0.025 to about 0.5 wt. % based on the total weight of the composition.

19. The aqueous surface treating composition of claim 1, wherein the aminosilicone material is present in an amount of from about 1 to about 5 wt. % based on the total weight of the composition.

20. A substrate comprising a surface, wherein at least a portion of the surface is coated with the aqueous surface treating composition of claim 1.

21. The substrate of claim 20, wherein the substrate is wood-based, plasterboard, cement, wallpaper, previously coated surfaces, stucco, leather, plastic-based surfaces, plastic film, paper, cardboard, or metal.

22. A method of treating a substrate comprising applying the aqueous surface treating composition of claim 1 on at least a portion of a surface of the substrate.

23. A method of preparing the aqueous surface treating composition of claim 1 comprising mixing the polymer resin (a) and the aminosilicone material (b).

24. The method of claim 23, wherein the polymer (a) is an emulsion, and the aminosilicone material (b) is an emulsion, and the emulsions are mixed together.
